(19) United States
(12) Patent Application Publication
(10) Pub. No.: US 2020/0280229 A1
(43) Pub. Date: Sep. 3, 2020

(54) BUSBAR DEVICE AND METHOD OF MANUFACTURING BUSBAR DEVICE

(71) Applicant: Murata Manufacturing Co., Ltd., Nagaokakyo-shi (JP)

(72) Inventors: Takashi Sakurada, Nagaokakyo-shi (JP); Mitsutoshi Natsumeda, Nagaokakyo-shi (JP); Eiji Sakaguchi, Nagaokakyo-shi (JP); Hisato Amano, Nagaokakyo-shi (JP)

(21) Appl. No.: 16/798,942

(22) Filed: Feb. 24, 2020

(30) Foreign Application Priority Data
Feb. 28, 2019 (JP) 2019-036204

(51) Int. Cl. H02K 3/04; H02K 15/04; H02K 3/46; H02K 15/10; H02K 15/00; H02G 5/00

(52) U.S. Cl. CPC H02K 3/04; H02K 15/04; H02K 3/46; H02K 2203/09; H02K 15/0068; H02G 5/005; H02K 15/10

(57) ABSTRACT

A busbar device includes an insulating sheet that is annularly formed by laminating an insulating layer and an adhesive layer and also includes an annular busbar. Moreover, the busbar is adhered to the adhesive layer. The insulating sheet and the busbar are laminated in a direction parallel to a central axis of the busbar.

### CROSS REFERENCE TO RELATED APPLICATIONS

The present application claims priority to Japanese Patent Application No. 2019-036204, filed Feb. 28, 2019, the entire contents of which are incorporated herein by reference.

### FIELD OF THE INVENTION

The present invention relates to a busbar device to be used in a motor or a generator.

### BACKGROUND

Currently, various types of bus rings for motors have been devised. For example, a bus ring according to Japanese Patent No. 6149673 is formed by laminating insulating sheets and busbars. The insulating sheets have holes and are aligned by inserting a positioning member into the holes.

Moreover, the bus ring described in Japanese Patent 6149673 needs to use the holes for the alignment of insulating sheets. However, this complicates the structure of each insulating sheet and also complicates a device on which the insulating sheets are mounted. As a result, a contact failure may occur during manufacturing the bus ring.

### SUMMARY OF THE INVENTION

Accordingly, a busbar device of the present invention enables components to be aligned easily with a simple structure.

According to exemplary embodiments of the present invention, a busbar device includes at least one insulating sheet that is annularly formed by laminating an insulating layer and an adhesive layer and also includes an annular busbar. Moreover, the busbar is adhered to the adhesive layer. The at least one insulating sheet and the busbar are laminated in a direction parallel to a central axis of the busbar.

With this configuration, the insulating sheet and the busbar are adhered to each other. This configuration reduces the likelihood of the busbars being displaced in a radial direction and in a circumferential direction when the busbar and the insulating sheet are laminated and pressed together.

Additional features, elements, characteristics and advantages of the exemplary embodiments will become more apparent from the following detailed description of the present invention with reference to the attached drawings.

### BRIEF DESCRIPTION OF THE DRAWINGS

FIG. 1 is a perspective view illustrating an external appearance of a busbar device according to a first exemplary embodiment.

FIG. 2 is an exploded perspective view illustrating the busbar device according to the first exemplary embodiment.

FIG. 3 is a plan view illustrating the busbar device according to the first exemplary embodiment.

FIG. 4A is a perspective view illustrating an external appearance of an insulating sheet according to the first exemplary embodiment.

FIG. 4B is a cross section of the insulating sheet taken along line A-A in FIG. 4A.

FIG. 5 is a perspective view illustrating an external appearance of the busbar device of the first exemplary embodiment being in a manufacturing process.

FIG. 6A is a plan view illustrating the busbar device according to the first exemplary embodiment.

FIG. 6B is a cross section of the busbar device taken along line B-B in FIG. 6A.

FIG. 7 is a flowchart illustrating a manufacturing process of the busbar device according to the first exemplary embodiment.

FIG. 8 is a perspective view illustrating an external appearance of a busbar device according to a second exemplary embodiment.

FIG. 9A is a perspective view illustrating an external appearance of a motor according to a third exemplary embodiment.

FIG. 9B is a cross section of the motor taken along line C-C in FIG. 9A.

FIG. 10A is a perspective view illustrating an external appearance of a busbar device according to a fourth exemplary embodiment.

FIG. 10B is a cross section of the busbar device taken along line D-D in FIG. 10A.

FIG. 11A is a perspective view illustrating an external appearance of a busbar device according to a fifth exemplary embodiment.

FIG. 11B is a cross section of the busbar device taken along line B-B in FIG. 11A.

### DETAILED DESCRIPTION OF THE EMBODIMENTS

### First Exemplary Embodiment

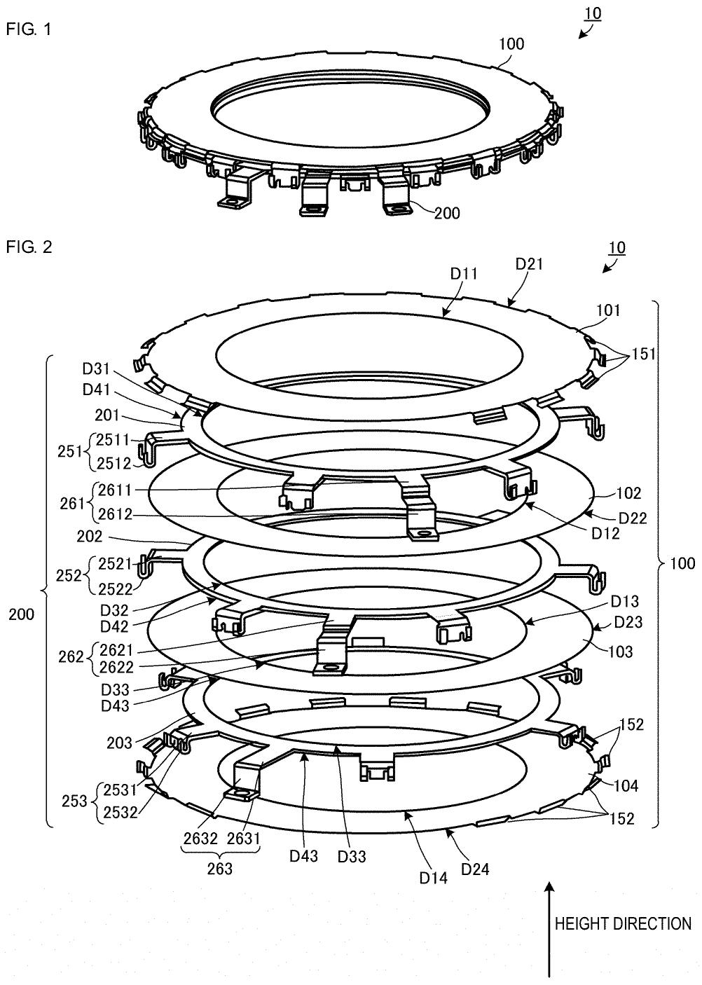

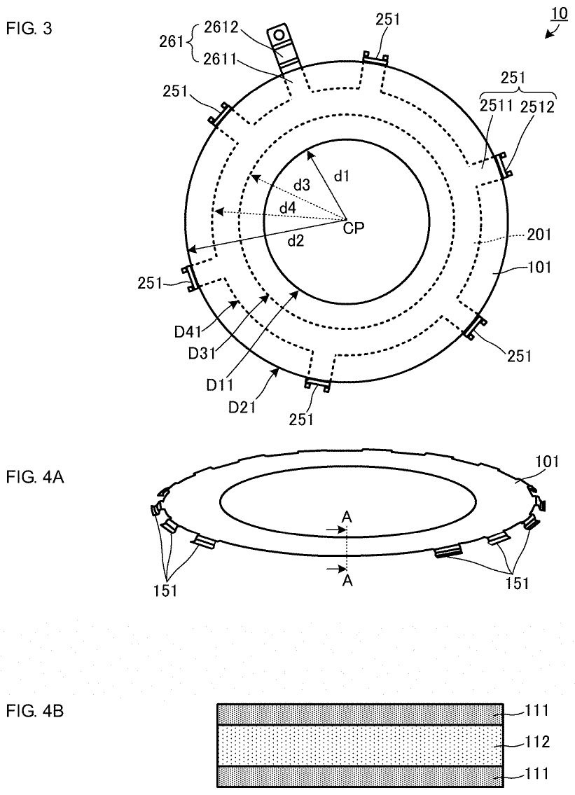

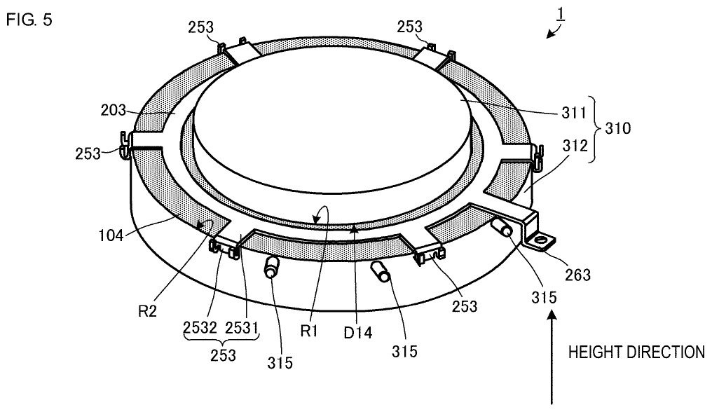

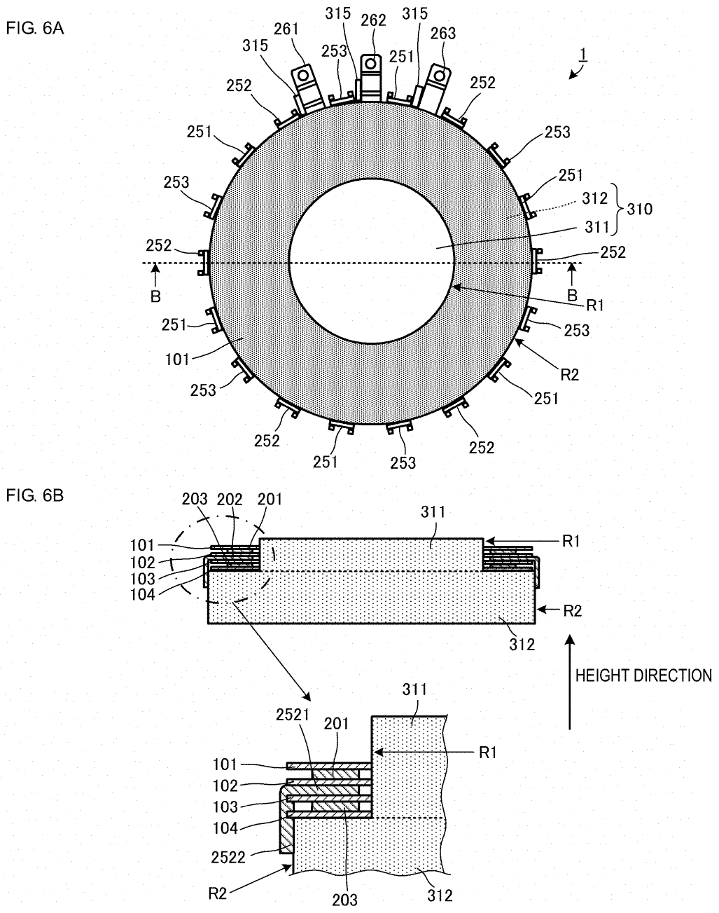

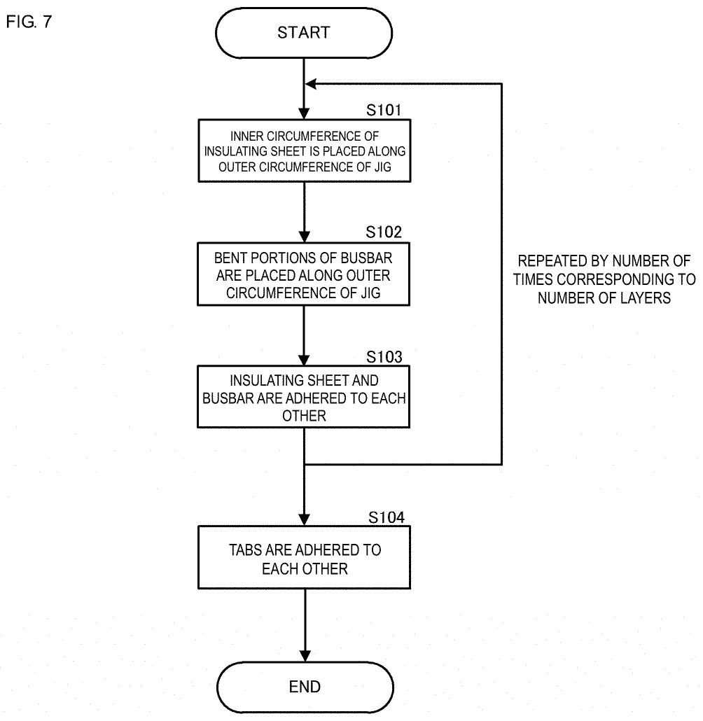

A busbar device according to a first exemplary embodiment will be described with reference to the drawings. FIG. 1 is a perspective view illustrating an external appearance of a busbar device 10 according to the first embodiment. FIG. 2 is an exploded perspective view illustrating the busbar device 10 according to the first embodiment. FIG. 3 is a plan view illustrating the busbar device 10 according to the first embodiment. FIG. 4A is a perspective view illustrating an external appearance of an insulating sheet 101 according to the first embodiment, and FIG. 4B is a cross section of the insulating sheet 101 taken along line A-A in FIG. 4A. FIG. 5 is a perspective view illustrating an external appearance of the busbar device 10 according to the first embodiment. FIG. 6A is a plan view illustrating the busbar device 10 according to the first embodiment, and FIG. 6B is a cross section of the busbar device 10 taken along line B-B in FIG. 6A. FIG. 7 is a flowchart illustrating a manufacturing process of the busbar device 10 according to the first embodiment. In figures provided for describing the following exemplary embodiments, it should be appreciated that relationships between vertical and lateral dimensions may be exaggerated from time to time and may not reflect actual dimensions. Some reference symbols may be omitted to improve visual recognition.

As illustrated in FIGS. 1 and 2, the busbar device 10 includes an insulating sheet unit 100 and a busbar unit 200. The insulating sheet unit 100 has a predetermined thickness and includes annularly shaped insulating sheets 101, 102, 103, and 104. The busbar unit 200 has a predetermined thickness and includes annularly shaped busbars 201, 202, and 203. In general, the thickness of each insulating sheet 101, 102, 103, or 104 is smaller than the thickness of each busbar 201, 202, or 203.

Structure of Insulating Sheet

A structure of the insulating sheet unit 100 will be described with reference to FIG. 2. As described, the insulating sheet unit 100 includes the insulating sheets 101, 102, 103, and 104.

The insulating sheet 101 has an annular shape and has an inner circumference D11 and an outer circumference D21. The insulating sheet 101 has multiple tabs 151 that protrude outward from the outer circumference D21.

The insulating sheet 102 has an annular shape and has an inner circumference D12 and an outer circumference D22. The insulating sheet 103 has an annular shape and has an inner circumference D13 and an outer circumference D23.

The insulating sheet 104 has an annular shape and has an inner circumference D14 and an outer circumference D24. The insulating sheet 104 has multiple tabs 152 that protrude outward from the outer circumference D24.

As further shown, the shapes of the inner circumferences D11, D12, D13, and D14 are preferably the same. The shapes of the outer circumferences D21, D22, D23, and D24 are also preferably the same. This can simplify the manufacturing process of the insulating sheets 101, 102, 103, and 104.

Structure of Busbar

Next, a structure of the busbar unit 200 will be described with reference to FIG. 2. As described, the busbar unit 200 includes the busbars 201, 202, and 203. The busbars 201, 202, and 203 are made, for example, of copper (Cu) in an exemplary aspect.

The busbar 201 has an inner circumference D31 and an outer circumference D41. The busbar 201 includes multiple connection terminals 251 and an output terminal 261 that protrude outward from the outer circumference D41.

Each connection terminal 251 includes a link portion 2511 and a bent portion 2512. The output terminal 261 includes a link portion 2611 and a bent portion 2612. Each of the link portions 2511 and the link portion 2611 is formed so as to be flush with a tabular region of the annular busbar 201 defined between the inner circumference D31 and the outer circumference D41 and is formed so as to have one end connected to the outer circumference D41. Each bent portion 2512 is connected to the other end of each link portion 2511 and is formed into a U-shape that extends in the height direction. It is noted that the height direction is a direction that orthogonally intersects the tabular region of the busbar 201, which can be considered a direction parallel to a central axis of the busbar in the present disclosure.

The busbar 202 has an inner circumference D32 and an outer circumference D42. The busbar 202 includes multiple connection terminals 252 and an output terminal 262 that protrude outward from the outer circumference D42.

Each connection terminal 252 includes a link portion 2521 and a bent portion 2522. The output terminal 262 includes a link portion 2621 and a bent portion 2622. Each of the link portions 2521 and the link portion 2621 is formed so as to be flush with a tabular region of the annular busbar 202 defined between the inner circumference D32 and the outer circumference D42 and is formed so as to have one end connected to the outer circumference D42. Each bent portion 2522 is connected to the other end of each link portion 2521 and is formed into a U-shape that extends in the height direction.

The busbar 203 has an inner circumference D33 and an outer circumference D43. The busbar 203 includes multiple connection terminals 253 and an output terminal 263 that protrude outward from the outer circumference D43.

Each connection terminal 253 includes a link portion 2531 and a bent portion 2532. The output terminal 263 includes a link portion 2631 and a bent portion 2632. Each of the link portion 2531 and the link portion 2631 is formed so as to be flush with a tabular region of the annular busbar 203 defined between the inner circumference D33 and the outer circumference D43 and is formed so as to have one end connected to the outer circumference D43. Each bent portion 2532 is connected to the other end of each link portion 2531 and is formed into a U-shape that extends in the height direction.

According to an exemplary aspect, the bent portions 2512 are provided at at least three positions along the outer circumference D41 of the busbar 201 so as to surround the central axis of the busbar 201. Moreover, the bent portions 2522 are provided at at least three positions along the outer circumference D42 of the busbar 202 so as to surround the central axis of the busbar 202. Likewise, the bent portions 2532 are provided at at least three positions along the outer circumference D43 of the busbar 203 so as to surround the central axis of the busbar 203.

The connection terminals 251, the connection terminals 252, and the connection terminals 253 have similar shapes but different lengths. Moreover, the output terminal 261, the output terminal 262, and the output terminal 263 have similar shapes. It is noted that the output terminals 261, 262, and 263 are input/output terminals for electric power.

The connection terminals 251, 252, and 253 and the output terminals 261, 262, and 263 are disposed systematically along the outer circumference D43. Here, the distance from the center of the busbar 201 to the inside surface (i.e., the surface near the center) of bent portion 2512 of each connection terminal 251 is the same as the distance from the center of the busbar 202 to the inside surface of the bent portion 2522 of each connection terminal 252 and the distance from the center of the busbar 203 to the inside surface of the bent portion 2532 of each connection terminal 253. Structural details will be described later.

Positional Relationship of Busbar Device and Insulating Sheet

Positional relationships of the insulating sheets 101, 102, 103, and 104 and the busbars 201, 202, and 203, which form the busbar device 10, will be described with reference to FIG. 2.

The busbar device 10 is formed by laminating, vertically from bottom to top, the insulating sheet 104, the busbar 203, the insulating sheet 103, the busbar 202, the insulating sheet 102, the busbar 201, and the insulating sheet 101.

The insulating sheet 104 and the busbar 203 are adhered to each other at opposing surfaces. Similarly, the busbar 203 and the insulating sheet 103 are adhered to each other at opposing surfaces.

For purposes of this disclosure, the insulating sheet 104 can be considered a first insulating sheet, and the insulating sheet 103 can be considered a second insulating sheet. Moreover, the surface of the busbar 203 opposing the insulating sheet 104 can be considered a first principal surface, and the surface of the busbar 203 opposing the insulating sheet 103 can be considered a second principal surface.

The insulating sheet 103 and the busbar 202 are adhered to each other at opposing surfaces. The busbar 202 and the insulating sheet 102 are adhered to each other at opposing surfaces.

According to the present disclosure, the insulating sheet 103 can be considered a first insulating sheet, and the insulating sheet 102 can be considered a second insulating sheet. Moreover, the surface of the busbar 202 opposing the insulating sheet 103 can be considered a first principal surface, and the surface of the busbar 202 opposing the insulating sheet 102 can be considered a second principal surface.

The insulating sheet 102 and the busbar 201 are adhered to each other at opposing surfaces. The busbar 201 and the insulating sheet 101 are adhered to each other at opposing surfaces.

According to the present disclosure, the insulating sheet 102 can be considered a first insulating sheet, and the insulating sheet 101 can be considered a second insulating sheet. Moreover, the surface of the busbar 201 opposing the insulating sheet 102 can be considered a first principal surface, and the surface of the busbar 201 opposing the insulating sheet 101 can be considered a second principal surface.

Thus, the insulating sheet unit 100 and the busbar unit 200 are adhered to each other.

The tabs 151 of the insulating sheet 101 and the tabs 152 of the insulating sheet 104 are formed such that the tabs 151 overlap respective tabs 152 as viewed vertically from above the busbar device 10. Accordingly, the tabs 151 come into contact with the tabs 152 when the insulating sheet 101 and the insulating sheet 104 are laminated.

Here, it is preferable that the entire surfaces of the busbars 201, 202, and 203 be adhered to corresponding insulating sheets 101, 102, 103, and 104 according to an exemplary aspect. This can reduce the likelihood of the busbars deviating in a radial direction and in a circumferential direction when the busbar device 10 is formed by laminating and pressing the busbars.

The connection terminals 251, 252, and 253 and the output terminals 261, 262, and 263 are formed so as not to overlap each other as viewed vertically from above the busbar device 10. Similarly, the tabs 151 and 152 are formed so as not to overlap the connection terminals 251, 252, and 253 and the output terminals 261, 262, and 263 as viewed vertically from above the busbar device 10. In other words, each pair of the tabs 151 and 152 is formed between adjacent ones of the connection terminals 251, 252, and 253 and the output terminals 261, 262, and 263.

Each tab 151 is adhered to the corresponding tab 152 at opposing surfaces thereof.

FIG. 3 is a plan view illustrating the busbar device 10. In FIG. 3, the insulating sheet 101 and the busbar 201 are illustrated by way of example. However, the same configuration applies to the insulating sheets 102, 103, and 104 and to the busbars 202 and 203. It is noted that the tabs 151 of the insulating sheet 101 are omitted to facilitate clear understanding.

For purposes of this disclosure, when the busbar device 10 is viewed in a plan view, a center CP of the busbar device 10 corresponds to the center of the insulating sheet 101 and the center of the busbar 201.

Moreover, d1 denotes the distance from the center CP to the inner circumference D11 of the insulating sheet 101, and d2 denotes the distance from the center CP to the outer circumference D21 of the insulating sheet 101. Similarly, d3 denotes the distance from the center CP to the inner circumference D31 of the busbar 201, and d4 denotes the distance from the center CP to the outer circumference D41 of the busbar 201. The width of the insulating sheet 101 (i.e., d2−d1) is greater than the width of the busbar 201 (i.e., d4−d3). Moreover, in an exemplary embodiment, the insulating sheet 101 and the busbar 201 are formed so as to satisfy the following formula: distance d1<distance d3<distance d4<distance d2.

With this configuration, the insulating sheets 101, 102, 103, and 104 cover the busbars 201, 202, and 203 over both of the annular principal surfaces and the outer and inner circumferential surfaces thereof. In other words, the busbar unit 200 is shaped so as to be covered by the insulating sheet unit 100. As a result, the busbars 201, 202, and 203 are insulated individually, which improves isolation of the busbars 201, 202, and 203 from each other.

Moreover, with this configuration, the insulating sheets 101, 102, 103 and 104 can be adhered appropriately to the busbars 201, 202, and 203, for example, during handling of components when the busbar device 10 is formed even if each insulating sheet does not have a complicated registration arrangement. Accordingly, misregistration of the busbar unit 200 and the insulating sheet unit 100 relative to each other can be suppressed. This can simplify the structure of the insulating sheet, which improves the yield rate of the product.

In addition, the tabs 151 and the corresponding tabs 152 are adhered to each other at the opposing surfaces thereof, which improves the adhesion strength between the insulating sheet 101 and the insulating sheet 104. The adhered tabs 151 and 152 are positioned outside the outer circumferences of the busbars. Accordingly, the likelihood of the busbars deviating outward in a radial direction can be reliably suppressed due to the adhesion strength of the tabs 151 and 152. It is noted that tabs may be provided for the insulating sheet 102 and the insulating sheet 103 to improve the adhesion strength further.

It is also noted that in the case of the busbar device 10 being used in an environment where foreign matter (such as water, oil, or metal powder) is not likely to enter the busbar device 10, the tabs 151 and 152 may be omitted.

The structure of the insulating sheet unit 100 will be described more specifically with reference to FIGS. 4A and 4B. Although FIG. 4B illustrates the insulating sheet 101 as an example, the same configuration applies to the insulating sheets 102, 103, and 104.

As illustrated in FIG. 4B, the insulating sheet 101 is formed by laminating an adhesive layer 111, an insulating layer 112, and another adhesive layer 111. In other words, the adhesive layers 111 are disposed on respective principal surfaces of the insulating layer 112.

Each adhesive layer 111 is made, for example, of an acrylic adhesive, a polysilan adhesive, or a polyurethane adhesive. It is noted that the adhesive layer 111 may be made of any adhesive material but is preferably made of an acrylic adhesive. The adhesive layer 111 made of the acrylic adhesive has thermal resistance and provides sufficient adhesiveness even if the layer is thin.

It is preferable that the adhesive layer 111 and the insulating layer 112 have the same thickness. However, the adhesive layer 111 and the insulating layer 112 may have different thicknesses insofar as the adhesive layer 111 and the insulating layer 112 can be adhered to each other. The adhesive layer 111 may be formed of a cohesive material.

Furthermore, the insulating layer 112 is made of a thermoplastic engineering plastic material, such as polyphenylene sulfide (PPS), polyethylene terephthalate (PET), polyethylene naphthalate (PEN), or aromatic polyamide.

In an exemplary aspect, the adhesive layer 111 may cover only one principal surface of the insulating layer 112. Moreover, the adhesive layer 111 may be omitted especially for the principal surface of the insulating sheet 101 that does not come into contact with the busbar 201. Similarly, the adhesive layer 111 may be omitted especially for the principal surface of the insulating sheet 104 that does not come into contact with the busbar 203.

Next, a structure of the busbar device 10 will be described with reference to FIGS. 5, 6A, and 6B. The busbar device 10 is manufactured using a first jig 310. In these figures, the tabs 151 of the insulating sheet 101 and the tabs 152 of the insulating sheet 104 are not illustrated to improve visual recognition.

As illustrated in FIG. 5, the first jig 310 includes a first portion 311 and a second portion 312. Although the positional relationship is described by focusing on the insulating sheet 104 and the busbar 203, the same relationship is also applied to the insulating sheets 101, 102, and 103 and the busbars 201 and 202. The insulating sheet 104 is marked by hatching to clarify the positional relationship between the insulating sheet 104 and the busbar 203.

The first jig 310 is formed by layering the columnar first portion 311 on top of the columnar second portion 312. The first jig 310 is preferably formed such that the center of the first portion 311 corresponds to the center of the second portion 312 when the first jig 310 is viewed in plan.

Here, R1 denotes the outer circumference of the first portion 311, and R2 denotes the outer circumference of the second portion 312. When the first jig 310 is viewed in plan, the first portion 311 is smaller than the second portion 312. In other words, the outer circumference R1 of the first portion 311 is smaller than the outer circumference R2 of the second portion 312. The first jig 310 includes multiple protrusions 315 that protrude outward from the outer circumference R2 of the second portion 312.

The insulating sheet 104 is placed so as to surround the outer circumference R1 of the first portion 311. More specifically, the inner circumference D14 of the insulating sheet 104 is placed along the outer circumference R1 of the first portion 311.

In other words, the outer circumference R1 of the first portion 311 has substantially the same shape and size as the shape and size of the inner circumference D14 of the insulating sheet 104. This facilitates alignment of the insulating sheet 104 when the insulating sheet 104 is placed on the first jig 310 (around the first portion 311).

The busbar 203 is also placed on the first jig 310 such that the bent portions 2532 of the busbar 203 are brought into contact with the outer circumference R2 of the second portion 312. In other words, the distance from the center of the second portion 312 to the outer circumference R2 (i.e., the radius of the second portion 312) is substantially the same as the distance from the center of the busbar 203 to each bent portion 2532. This facilitates alignment of the busbar 203 when the busbar 203 is placed on the first jig 310 (around the second portion 312).

Structural details of the busbar device 10 will be described with reference to FIGS. 6A and 6B. In FIG. 6A, the insulating sheet 101 is marked by hatching to clarify the positional relationship between the insulating sheet 101 and the first jig 310.

As illustrated in FIGS. 6A and 6B, the insulating sheets 101, 102, 103, and 104 are arranged so as to surround the outer circumference R1 of first portion 311 of the first jig 310. More specifically, the inner circumference D11 of the insulating sheet 101, the inner circumference D12 of the insulating sheet 102, the inner circumference D13 of the insulating sheet 103, and the inner circumference D14 of the insulating sheet 104 are placed along the outer circumference R1 of first portion 311 of the first jig 310 and aligned in the height direction.

The busbars 201, 202, and 203 are arranged on the first jig 310 such that the connection terminals 251, 252, and 253 are placed along the outer circumference R2 of second portion 312 of the first jig 310.

In addition, the output terminals 261, 262, and 263 are aligned by using protrusions 315. In other words, the protrusions 315 are used for positioning the busbars 201, 202, and 203 in a circumferential direction.

As further shown in FIG. 6B, the inner circumference D11 of the insulating sheet 101, the inner circumference D12 of the insulating sheet 102, the inner circumference D13 of the insulating sheet 103, and the inner circumference D14 of the insulating sheet 104 come into contact with the outer circumference R1 of the first portion 311. Moreover, the bent portions 2512 of the connection terminals 251, the bent portions 2522 of the connection terminals 252, and the bent portions 2532 of the connection terminals 253 come into contact with the surface of outer circumference R2 of the second portion 312.

Thus, when the insulating sheets 101, 102, 103, and 104 and the busbars 201, 202, and 203 are placed on the first jig 310, these components can be aligned easily. The output terminals 261, 262, and 263 can be disposed so as not to interfere with each other due to the protrusions 315 determining the positions of the output terminals 261, 262, and 263. This configuration suppresses deviation of the insulating sheet unit 100 and the busbar unit 200 relative to each other. Accordingly, the configuration simplifies the structure of the insulating sheet.

In the case of the busbars 201, 202, and 203 being heated while power is supplied, the busbars 201, 202, and 203 may expand toward the outside of the outer circumferences of the busbars. In this case, the outer circumferences of respective busbars 201, 202, and 203 may break the mutual adhesion of the insulating sheets 101, 102, 103, and 104, which may degrade insulation performance. However, the outer circumferences of the insulating sheets 101, 102, 103, and 104 are positioned at or near the outer circumference R2 of the second portion 312, while the busbars 201, 202, and 203 are disposed so as to be closer to the outer circumference R1 of the first portion 311 than to the outer circumference R2 of the second portion 312. Accordingly, the busbars 201, 202, and 203 are disposed closer to the inner circumferences of the insulating sheets 101, 102, 103, and 104. This configuration suppresses breakage of the insulating sheet unit 100 caused by expansion of the busbars 201, 202, and 203.

Next, a process of manufacturing the busbar device 10 using the first jig 310 will be described with reference to FIG. 7.

In step S101, the insulating sheet 104 is disposed such that the inner circumference D14 of the insulating sheet 104 is placed along the outer circumference R1 of first portion 311 of the first jig 310.

In step S102, the busbar 203 is placed such that the bent portions 2532 of the busbar 203 are brought into contact with the outer circumference R2 of second portion 312 of the first jig 310.

In step S103, the insulating sheet 104 and the busbar 203 are adhered to each other.

Steps S101, S102, and S103 are repeated by the number of times corresponding to the number of layers of the busbar and insulating sheet. In the present embodiment, the insulating sheets 101, 102, and 103 and the busbars 201 and 202 are subsequently laminated and adhered.

In step S104, the tabs 151 of the insulating sheet 101 are adhered to the corresponding tabs 152 of the insulating sheet 104.

By using the above manufacturing process, the members of the busbar device 10 can be aligned easily when placed on the first jig 310, and the positional relationships of the insulating sheets 101, 102, 103, and 104 and the busbars 201, 202, and 203 can be fixed reliably.

According to an exemplary aspect, it is preferable that the shapes of at least the insulating sheet 101 and the insulating sheet 104 excluding respective tabs 151 and 152 be substantially the same. It is also preferable that the width of at least the insulating sheets 102 and 103 be greater than the width of the busbars 201, 202, and 203.

The insulating sheets 101, 102, 103, and 104 described above are examples having annular shapes. However, each insulating sheet may have a polygonal shape or may be formed into an annular shape by combining multiple sheet segments together circumferentially.

Similarly, the busbars 201, 202, and 203 described above are examples having annular shapes. However, each busbar may have a polygonal shape or may be formed into an annular shape by combining multiple busbar segments together circumferentially.

In addition, the first jig 310 described above is an example having a columnar first portion 311 and a columnar second portion 312. However, the first jig 310 can function similarly in the case in which the first portion 311 and the second portion 312 have polygonal shapes each of which has three corners or more.

### Second Exemplary Embodiment

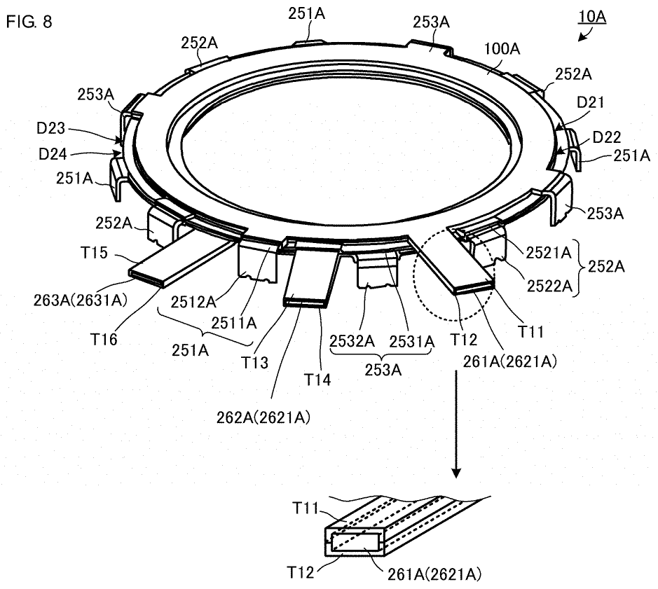

A busbar device according to a second embodiment of the present invention will be described with reference to the drawings. FIG. 8 is a perspective view illustrating an external appearance of a busbar device 10A according to the second embodiment.

As illustrated in FIG. 8, the shapes of insulating sheets 101A, 102A, 103A, and 104A, the shapes of connection terminals 251A, 252A, and 253A, and the shapes of output terminal 261A, 262A, 263A of the busbar device 10A according to the second embodiment are different from those of the busbar device 10 according to the first embodiment. Additional configurations of the busbar device 10A are similar to those of the busbar device 10, and the description of similar configurations will not be repeated.

The busbar 201A includes connection terminals 251A and an output terminal 261A. The busbar 202A includes connection terminals 252A and an output terminal 262A. The busbar 203A includes connection terminals 253A and an output terminal 263A.

The output terminal 261A includes a link portion 2611A but does not include a bent portion. The output terminal 262A includes a link portion 2621A but does not include a bent portion. The output terminal 263A includes a link portion 2631A but does not include a bent portion.

As further shown, the insulating sheets 101A and 102A are shaped so as to cover the output terminal 261A entirely. More specifically, the insulating sheet 101A includes a rectangularly shaped strip portion T11 at a position corresponding to the output terminal 261A. The strip portion T11 protrudes outward from the outer circumference D21 of the insulating sheet 101A. In addition, the insulating sheet 102A includes a rectangularly shaped strip portion T12 at a position corresponding to the output terminal 261A. The strip portion T12 protrudes outward from the outer circumference D22 of the insulating sheet 102A.

The strip portion T11 is shaped so as to have a size that is larger than the output terminal 261A when measured in a direction parallel to the surface of the output terminal 261A with which the strip portion T11 comes into contact, and the strip portion T12 is shaped so as to have a size larger than the output terminal 261A when measured in a direction parallel to the surface of the output terminal 261A with which the strip portion T12 comes into contact. The strip portion T11 and the strip portion T12 having such shapes come into contact with the output terminal 261A and thereby cover the output terminal 261A entirely.

Similarly, the insulating sheets 102A and 103A are shaped so as to cover the output terminal 262A entirely. More specifically, the insulating sheet 102A includes a rectangularly shaped strip portion T13 at a position corresponding to the output terminal 262A. The strip portion T13 protrudes outward from the outer circumference D22 of the insulating sheet 102A. In addition, the insulating sheet 103A includes a rectangularly shaped strip portion T14 at a position corresponding to the output terminal 262A. The strip portion T14 protrudes outward from the outer circumference D23 of the insulating sheet 103A.

The strip portion T13 is also shaped so as to have a size larger than the output terminal 262A when measured in a direction parallel to the surface of the output terminal 262A with which the strip portion T13 comes into contact, and the strip portion T14 is shaped so as to have a size larger than the output terminal 262A when measured in a direction parallel to the surface of the output terminal 262A with which the strip portion T14 comes into contact. The strip portion T13 and the strip portion T14 having such shapes come into contact with the output terminal 262A and thereby cover the output terminal 262A entirely.

Furthermore, the insulating sheets 103A and 104A are shaped so as to cover the output terminal 263A entirely. More specifically, the insulating sheet 103A includes a rectangularly shaped strip portion T15 at a position corresponding to the output terminal 263A. The strip portion T15 protrudes outward from the outer circumference D23 of the insulating sheet 103A. In addition, the insulating sheet 104A includes a rectangularly shaped strip portion T16 at a position corresponding to the output terminal 263A. The strip portion T16 protrudes outward from the outer circumference D24 of the insulating sheet 104A.

As further shown, the strip portion T15 is shaped so as to have a size larger than the output terminal 263A when measured in a direction parallel to the surface of the output terminal 263A with which the strip portion T15 comes into contact, and the strip portion T16 is shaped so as to have a size larger than the output terminal 263A when measured in a direction parallel to the surface of the output terminal 263A with which the strip portion T16 comes into contact. The strip portion T15 and the strip portion T16 having such shapes come into contact with the output terminal 263A and thereby cover the output terminal 263A entirely.

Accordingly, the output terminals 261A, 262A, and 263A are covered by the corresponding insulating sheets 101A, 102A, 103A, and 104A.

When insulating sheets cover respective output terminals 261A, 262A, and 263A entirely, the insulating sheets cover both tabular surfaces of each output terminal and side surfaces connected to the tabular surfaces so as not to impair the connection function of the output terminals 261A, 262A, and 263A.

With this configuration, not only the busbars 201A, 202A, and 203A, but also the output terminals 261A, 262A, and 263A are insulated individually to improve isolation of these components from each other.

As further shown, each connection terminal 251A includes a link portion 2511A and a bent portion 2512A. The link portion 2511A is flush with the busbar 201A. The bent portion 2512A is bent so as to extend in the height direction.

Moreover, each connection terminal 252A includes a link portion 2521A and a bent portion 2522A. The link portion 2521A is flush with the busbar 202A. The bent portion 2522A is bent so as to extend in the height direction.

Furthermore, each connection terminal 253A includes a link portion 2531A and a bent portion 2532A. The link portion 2531A is flush with the busbar 203A. The bent portion 2532A is bent so as to extend in the height direction.

With this configuration, alignment of members of the busbar device 10A when disposed on the jig or the like can be achieved easily by using the bent portions 2512A, 2522A, and 2532A. The positional relationships of the insulating sheets 101A, 102A, 103A, and 104A and the busbars 201A, 202A, and 203A can be thereby fixed reliably. In addition, not only the busbars 201A, 202A, and 203A but also the output terminals 261A, 262A, and 263A are insulated individually, which improves isolation of these components from each other.

Moreover, the strip portions T11, T12, T13, T14, T15, and T16 are formed in corresponding insulating sheets 101A, 102A, 103A, and 104A, which can reliably cover the output terminals 261A, 262A, and 263A and also can improve the strength of mutual adhesion of the insulating sheets 101A, 102A, 103A, and 104A.

### Third Exemplary Embodiment

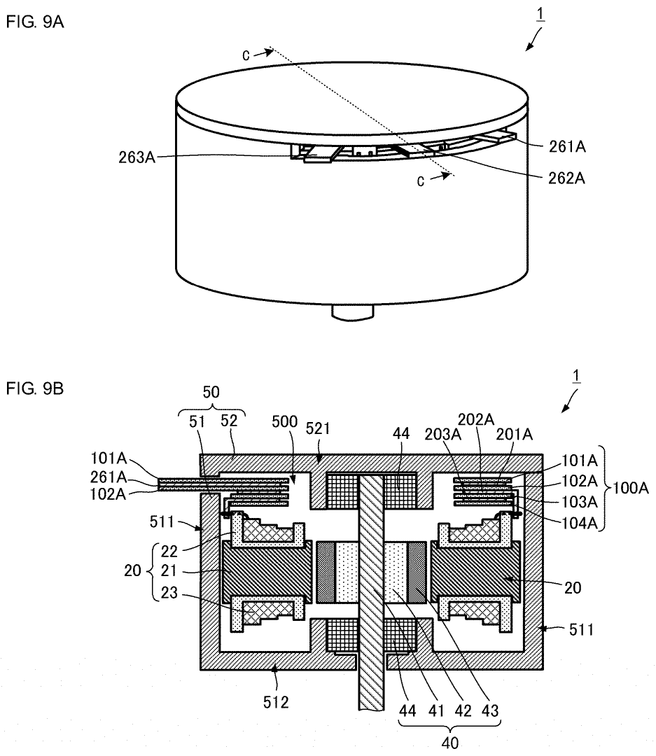

A busbar device according to a third embodiment of the present invention will be described with reference to the drawings. FIG. 9A is a perspective view illustrating an external appearance of a motor 1 according to the third embodiment, which is housed in a housing 50. FIG. 9B is a cross section of the motor 1 taken along line C-C in FIG. 9A.

As illustrated in FIGS. 9A and 9B, the motor 1 according to the third embodiment includes the busbar device 10A according to the second embodiment, stators 20, a rotor 40, and the housing 50.

As illustrated in FIGS. 9A and 9B, the motor 1 includes multiple stators 20, the busbar device 10A, the rotor 40, and the housing 50. It is noted that the third exemplary embodiment is described by using a motor as an example. However, the motor can be substituted by a power generator.

The housing 50 includes a first member 51 and a second member 52. The first member 51 has a cylindrically shaped wall 511 and a tabularly shaped wall 512 that covers one end of the cylindrically shaped wall 511. The first member 51 is shaped like a cylindrical box having an opening. The second member 52 is shaped tabularly. The second member 52 has the tabularly shaped wall 521. The second member 52 is disposed so as to cover the opening of the first member 51. Accordingly, the housing 50 has a space 500 enclosed by the wall 511, the wall 512, and the wall 521. The first member 51 and the second member 52 are made of a material having a high rigidity.

The stators 20, the busbar device 10A, and the rotor 40 are disposed in the space 500 defined by the housing 50. The rotor 40 is disposed in a central region when the walls 521 and 512 are viewed in plan. In other words, the rotor 40 is disposed in the central region that has a predetermined size and that includes a central axis of the cylindrical shape formed by the wall 511.

As illustrated in FIG. 9B, multiple stators 20 are disposed between the cylindrical wall 511 of the housing 50 and the rotor 40. The multiple stators 20 are disposed equidistantly and close to each other along the circumference of the cylindrical wall 511.

The busbar device 10A is disposed at a position close to the stators 20 in the axial direction of the housing 50. The busbar device 10A is connected to the stators 20. Part of each output terminal 261 of the busbar device 10A is taken out from the housing 50.

According to this configuration, the busbar device 10A is disposed in the state in which the positional relationships of the insulating sheets 101A, 102A, 103A, and 104A and the busbars 201A, 202A, and 203A are fixed, which can simplify manufacturing of the motor 1. In addition, the output terminal 261A, 262A, 263A are covered by the insulating sheet 101A, 102A, 103A, and 104A, which can provide reliable insulation between the busbar device 10A and the housing 50 or other components.

### Fourth Exemplary Embodiment

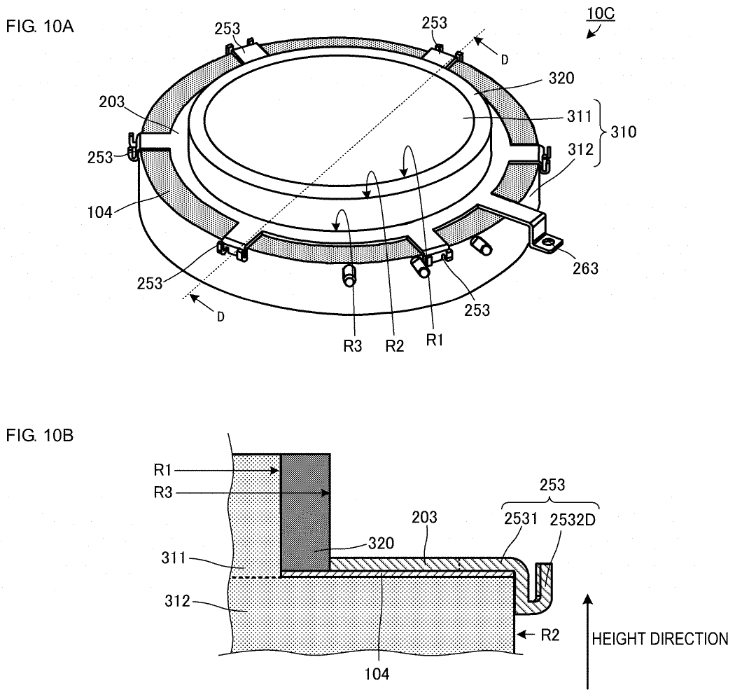

A busbar device according to a fourth embodiment of the present invention will be described with reference to the drawings. FIG. 10A is a perspective view illustrating an external appearance of a busbar device 10C according to the fourth embodiment. FIG. 10B is a cross section of the busbar device 10C taken along line D-D in FIG. 10A.

As illustrated in FIGS. 10A and 10B, the busbar device 10C according to the fourth embodiment is different from the busbar device 10 according to the first embodiment in that the busbar device 10C is manufactured by further using a second jig 320. Additional configurations of the busbar device 10C are similar to those of the busbar device 10, and the description of similar configurations will not be repeated. Although FIGS. 10A and 10B illustrate the insulating sheet 104 as an example, the same configuration applies to the insulating sheets 101, 102, and 103. Although FIGS. 10A and 10B illustrate the busbar 203 as an example, the same configuration applies to the busbars 201 and 202.

The second jig 320 is shaped so as to surround the outer circumference R1 of first portion 311 of the first jig 310. The second jig 320 has an outer circumference R3. The diameter of the outer circumference R3 is substantially equal to the diameter of inner circumference D33 of the busbar 203. The second jig 320 is removable from the first jig 310.

The insulating sheet 104 is placed such that the inner circumference D14 of the insulating sheet 104 follows the outer circumference R1 of the first portion 311 (of the first jig 310). Moreover, the busbar 203 is placed such that the inner circumference D33 of the busbar 203 follows the outer circumference R3 of the second jig 320. The second jig 320 is subsequently removed from the first jig 310. Next, the insulating sheet 103 is placed such that the inner circumference D13 of the insulating sheet 103 follows the outer circumference R1 of the first portion 311 (of the first jig 310). The busbar 202 is placed such that the inner circumference D32 of the busbar 202 follows the outer circumference R3 of the second jig 320. The above steps are repeated for the insulating sheets 101 and 102 and the busbar 201.

With this configuration, the inner circumference D31 of the busbar 201, the inner circumference D32 of the busbar 202, and the inner circumference D33 of the busbar 203 can be aligned.

With this configuration, when the busbar device 10 is manufactured, the insulating sheets 101, 102, 103, and 104 and the busbars 201, 202, and 203 can be aligned easily by using the first jig 310 and the second jig 320.

It is noted that since the inner circumferences of the busbars 201, 202, and 203 can be aligned by using the second jig 320, the bent portions 2532 can be omitted from the connection terminals 253.

### Fifth Exemplary Embodiment

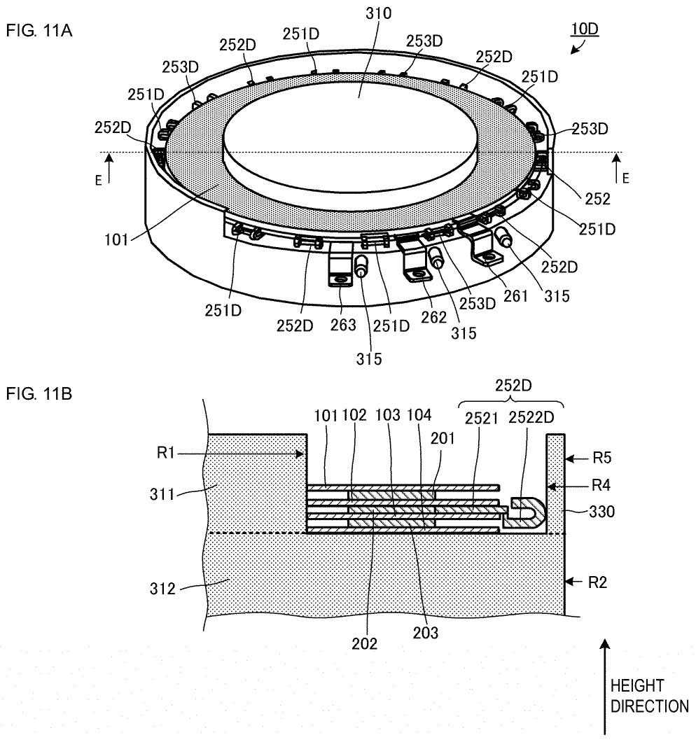

A busbar device according to a fifth embodiment of the present invention will be described with reference to the drawings. FIG. 11A is a perspective view illustrating an external appearance of a busbar device 10D according to the fifth embodiment. FIG. 11B is a cross section of the busbar device 10D taken along line B-B in FIG. 11A.

As illustrated in FIGS. 11A and 11B, the busbar device 10D according to the fifth embodiment is different from the busbar device 10 according to the first embodiment in that the busbar device 10D is formed by further using a third jig 330 and the busbar device 10D includes connection terminals 251D, 252D and 253D having different shapes. Additional configurations of the busbar device 10D are similar to those of the busbar device 10, and the description of similar configurations will not be repeated.

The third jig 330 has an arbitrary thickness and is shaped annularly. The third jig 330 has an inner circumference R4 and an outer circumference R5. The outer circumference R5 of the third jig 330 is flush with the outer circumference R2 of the first jig 310. A portion of the third jig 330 is removed so as to enable the output terminals 261, 262, and 263 to protrude outward while manufacturing the busbar device 10D.

Each connection terminal 251D includes a bent portion 2512D that is formed into a U-shape that extends in the height direction. Each connection terminal 252D includes a bent portion 2522D that is formed into a U-shape that extends in the height direction. Each connection terminal 253D includes a bent portion 2532D that is formed into a U-shape that extends in the height direction.

Similar to the above-described embodiments, the insulating sheets 101, 102, 103, and 104 are placed so as to surround the outer circumference R1 of the first portion 311 (of the first jig 310).

Moreover, the busbar 201 is placed such that the outside surfaces of bent portions 2512D of the connection terminals 251 come into contact with the inner circumference R4 of the third jig 330. The busbar 202 is placed such that the outside surfaces of bent portions 2522D of the connection terminals 252 come into contact with the inner circumference R4 of the third jig 330. Yet further, the busbar 203 is placed such that the outside surfaces of bent portions 2532D of the connection terminals 253 come into contact with the inner circumference R4 of the third jig 330.

The first jig 310 has multiple protrusions 315 that protrude outward from the outer circumference R2 of the second portion 312. The output terminals 261, 262, and 263 are aligned by using respective protrusions 315. In other words, the protrusions 315 can be used to position the busbars 201, 202, and 203 in a circumferential direction.

The bent portions 2512D, 2522D, and 2532D may be omitted from the connection portions, and link portions 2511, 2521, and 2531 may be used to achieve alignment.

With this configuration, when the busbar device 10 is manufactured, the insulating sheets 101, 102, 103, and 104 and the busbars 201, 202, and 203 can be aligned easily by using the first jig 310 and the third jig 330.

In general, it is noted that the exemplary embodiments of the present invention are not limited to the embodiments described above, and the configurations of the embodiments described may be combined with or replaced by one another.

Moreover, while exemplary embodiments have been described above, it is to be understood that variations and modifications will be apparent to those skilled in the art without departing from the scope and spirit of the invention.

What is claimed:

1. A busbar device comprising:
at least one insulating sheet having an annular shape and including an insulating layer laminated with an adhesive layer; and
an annular busbar that is adhered to the adhesive layer,
wherein the at least one insulating sheet and the busbar are laminated in a direction parallel to a central axis of the busbar.

2. The busbar device according to claim 1, wherein the at least one insulating sheet comprises an inner circumference that is smaller than an inner circumference of the busbar.

3. The busbar device according to claim 2, wherein the at least one insulating sheet comprises an outer circumference that is greater than an outer circumference of the busbar.

4. The busbar device according to claim 3, wherein the busbar is disposed between the inner circumference and the outer circumference of the at least one insulating sheet.

5. The busbar device according to claim 4, wherein the busbar is disposed at a position closer to the inner circumference of the at least one insulating sheet than to the outer circumference thereof.

6. The busbar device according to claim 4, wherein the at least one insulating sheet includes a first insulating sheet disposed on a first principal surface of the busbar and a second insulating sheet disposed on a second principal surface of the busbar that is opposite to the first principal surface, and the first insulating sheet is adhered to the second insulating sheet at a position radially outside of the busbar and at a position radially inside of the busbar.

7. The busbar device according to claim 1, wherein the at least one insulating sheet includes a plurality of insulating sheets having respective tabs protruding outward from respective outer circumferences of the insulating sheets, and the tabs are adhered to each other at a position radially outside of the busbar.

8. The busbar device according to claim 1,
wherein the busbar includes a plurality of connection terminals and a tabular region that extends between inner and outer circumferences of the busbar,
wherein the plurality of connection terminals have respective links disposed at the outer circumference of the busbar and are flush with the tabular region, and
wherein the plurality of connection terminals further comprise respective bent portions disposed at corresponding ends of the links.

9. The busbar device according to claim 8, wherein the at least one insulating sheet covers each of the plurality of connection terminals entirely.

10. The busbar device according to claim 9, wherein, in each of the plurality of connection terminals, the at least one insulating sheet covers the entirety of the link and exposes part of the bent portion.

11. The busbar device according to claim 1, wherein the adhesive layer comprises a cohesive material.

12. A method of manufacturing a busbar device comprising:
providing at least one jig formed by layering a columnar first portion and a columnar second portion, with the first portion having an outer circumference that is smaller than an outer circumference of the second portion;
disposing an inner circumference of at least one insulating sheet along the outer circumference of the first portion, with at least one insulating sheet having an annular shape and including an insulating layer laminated with an adhesive layer; and
disposing bent portions of an annular busbar along the outer circumference of the second portion, with the annular busbar being adhered to the adhesive layer,
wherein the at least one insulating sheet and the busbar are laminated in a direction parallel to a central axis of the busbar.

13. The method of manufacturing the busbar device according to claim 12, wherein the inner circumference of the at least one insulating sheet is smaller than an inner circumference of the busbar.

14. The method of manufacturing the busbar device according to claim 13, wherein the at least one insulating sheet comprises an outer circumference that is greater than an outer circumference of the busbar.

15. The method of manufacturing the busbar device according to claim 14, further comprising disposing the busbar between the inner circumference and the outer circumference of the at least one insulating sheet.

16. The method of manufacturing the busbar device according to claim 15, further comprising disposing the busbar at a position closer to the inner circumference of the at least one insulating sheet than to the outer circumference thereof.

17. The method of manufacturing the busbar device according to claim 15,
wherein the at least one insulating sheet includes a first insulating sheet disposed on a first principal surface of the busbar and a second insulating sheet disposed on a second principal surface of the busbar that is opposite to the first principal surface, and
wherein the method further comprises adhering the first insulating sheet to the second insulating sheet at a position radially outside of the busbar and at a position radially inside of the busbar.

18. A method of manufacturing a busbar device comprising:
providing a first jig that is formed by layering a columnar first portion and a columnar second portion;
providing a second jig that is annularly formed on a surface with which the first and second portions are in contact along an outer circumference of the second portion, with the first portion having an outer circumference that is smaller than the outer circumference of the second portion;
disposing an inner circumference of at least one insulating sheet along the outer circumference of the first portion, with at least one insulating sheet having an annular shape and including an insulating layer laminated with an adhesive layer; and
disposing most distant portions of an annular busbar from a central axis along an inner circumference of the second jig, with the annular busbar being adhered to the adhesive layer.

19. The method of manufacturing the busbar device according to claim 18, wherein the inner circumference of the at least one insulating sheet is smaller than an inner circumference of the busbar.

20. The method of manufacturing the busbar device according to claim 19, wherein the at least one insulating sheet comprises an outer circumference that is greater than an outer circumference of the busbar.
